(19) United States
(12) Patent Application Publication
(10) Pub. No.: US 2023/0400555 A1
(43) Pub. Date: Dec. 14, 2023

(54) DETECTION METHOD AND DETECTION SYSTEM

(71) Applicant: Ningbo ABAX Sensing Electronic Technology Co., Ltd., Ningbo City (CN)

(72) Inventor: Shuyu LEI, Ningbo City, Zhejiang Province (CN)

(73) Assignee: Ningbo ABAX Sensing Electronic Technology Co., Ltd., Ningbo City, Zh (CN)

(21) Appl. No.: 18/033,432

(22) PCT Filed: Oct. 27, 2021
(86) PCT No.: PCT/CN2021/126590

§ 371 Date: Apr. 24, 2023

(30) Foreign Application Priority Data
Oct. 30, 2020 (CN) 202011185790.7
Oct. 30, 2020 (CN) 202011187367.0
Oct. 30, 2020 (CN) 202011189912.X

(51) Int. Cl. G01S 7/481; G01S 7/499; G01S 7/48; G01S 17/04

(52) U.S. Cl. CPC G01S 7/4815; G01S 7/499; G01S 7/4808; G01S 17/04

(57) ABSTRACT

A detection method and system. The detection method is performed by the detection system comprising: a light emitting module comprising N emitting regions, N is an integer greater than or equal to 2, and emitted light of every two adjacent emitting regions has different polarization angles, a processing module, and a light receiving module comprising receiving regions corresponding to the N emitting regions, and every two adjacent receiving regions receive, at different polarization angles, light returned by a detected object. The detection method comprises: receiving, by at least some receiving regions, the return light outputted by at least two emitting regions; generating a photogenerated electrical signal under excitation of the return light with at least one of the polarization angles after being partially or fully filtered; and processing the photogenerated electrical signal to obtain final target information of the detected object.

### CROSS REFERENCE TO RELATED APPLICATIONS

The present application claims priorities to Chinese Patent Application No. 202011189912.X, titled “DETECTION METHOD AND DETECTION SYSTEM”, Chinese Patent Application No. 202011185790.7, titled “DETECTION METHOD AND DETECTION SYSTEM USING SAME”, and Chinese Patent Application No. 202011187367.0, titled “DETECTION METHOD AND DETECTION SYSTEM USING SAME”, filed on Oct. 30, 2020 with the Chinese Patent Office, all of which are incorporated herein by reference in their entireties.

### FIELD

The present disclosure relates to the technical field of lidar detection, and in particular to a detection method and a detection system.

### BACKGROUND

With the development of the lidar technology, the Time of flight (TOF) technology has received more and more attention. The principle of the TOF is described as follows. A light pulse is continuously emitted to an object, and a light returned from the object is received by a sensor, and the distance to the object is obtained by detecting the flight (round-trip) time of the light pulse. The currently commonly used methods include a direct time-of-flight detection method and an indirect time-of-flight detection method. In the direct time-of-flight detection method, the distance to the object is obtained based on a direct time difference between the emitted light and the return light. In the indirect time-of-flight detection method, a phase difference between the emitted light and the return light is obtained, a final flight time is obtained based on the phase difference, so as to calculate the distance to the object. Currently, the detection system is generally implemented by a Vertical-Cavity Surface-Emitting Laser (VCSEL). The laser emitting source is implemented by multiple laser emitting units arranged in an array. The laser source emits a detection light. The detection light is reflected by the detected object and enters the detection unit to be converted into photogenerated charges. The target distance or target image of the detected object is obtained by the subsequent signal processing circuit later to complete the detection.

In the normal distance measurement process, the distance to the detected object can be obtained without contacting the object by the direct or indirect time-of-flight measurement method. In the case of multi-point detection, the shape and contour of the object may be obtained by multi-point measurement settings, and a three-dimensional image is outputted by the post-processing. In the actual detection process, especially in the distance measurement process, the emitted light of the array light source is required to have a certain diffusion angle to ensure a sufficient view field. However, in the case of ensuring the view field, the emitted light projected by the light source has a large diffusion angle, in this case detection objects in the view field are more complex. For example, in the automatic driving view field, there are road, obstacles, people and other complex components. Further, for example, in the sweeping robot application, there are ground, wall corners, obstacles and so on. Moreover, for example, in the view field of a security camera, there are ground, corner, people, and so on. The above shows only an example of several application scenarios, which is not limited herein. In this case there are the following possibilities. For example, there are an obstacle A and a detected object B in the view field. The light source emits a detection laser light, and the emitted light is partially reflected by the detected object B back to the detector. However, there is also a part of the emitted light is reflected by the obstacle A while being not directly back to the detector, but is firstly reflected to the detected object B and returns back to the detector after the reflection of the detected object B. This phenomenon is especially serious in a case that there are highly reflective objects in the view field, or in a case that the detector carrier is near a corner. This phenomenon causes false values of distance detection in the output of the detector array, and the interference to the detection result caused by this phenomenon belongs to the multipath interference in the detection, and this phenomenon has a very serious limitation for the application of the detector and the realization of accurate detection. In a patent No. CN205621076U (titled “DIMENSIONAL MARKING SYSTEM WITH MULTIPATH INTERFERENCE MITIGATION”), a method for improving and constraining this multipath interference phenomenon is proposed, which is implemented by an adaptive adjustment structure in the light beam scenario, for example, an adjustable lens. By adaptively detecting the basic information of the field of view and adjusting the projection beam of the emission light, the projection light outputted by the light source limits the diffusion angle, so that the object or target of interest is projected emphatically, so as to obtain accurate detection results and eliminate the influence of multipath phenomenon. This method has certain practicability, but has certain restrictions for the scenario with multiple objects in the view field. The diffusion angle is required to be adjusted in the image acquisition or processing, making the whole solution more complex. Therefore, it is an urgent problem to be solved how to not only achieve a sufficient diffusion angle to ensure that the view field of view is sufficient, but also output the emitted light only for specific regions so as to realize projection on the object of interest by the constrained light beam in the existing technology, so as to weaken or eliminate the multipath phenomenon.

### SUMMARY

A detection method and a detection system are provided in the present disclosure, by which targeted projection can be performed on different regions to weaken or eliminate the multipath interference mentioned in the section of BACKGROUND.

Technical solutions in embodiments of the present disclosure are provided as follows.

In a first aspect, a detection method is provided according to an embodiment of the present disclosure. The detection method is performed by a detection system including a light emitting module, a processing module and a light receiving module. The light emitting module includes N emitting regions, where N is an integer greater than or equal to 2, lights respectively emitted from every two adjacent emitting regions among the emitting regions having different polarization angles. The light receiving module includes N receiving regions respectively corresponding to the N emitting regions in the light emitting module, and every two adjacent receiving regions among the receiving regions receiving a light returned from a detected object at different polarization angles. The detection method includes:
receiving, by at least some of the receiving regions in the light receiving module in at least part of a time period, the return light reflected by the detected object with different polarization angles that is outputted by at least two emitting regions;
generating a photogenerated electrical signal by the light receiving module under excitation of the return light with at least one of the polarization angles after being partially or fully filtered, corresponding to at least a part of a region of the return light with different polarization angles; and
processing, by the processing module, the photogenerated electrical signal generated by the light receiving module under the excitation of the return light after being filtered, to obtain final target information of the detected object.

In an embodiment, the detection system further includes a polarization module arranged upstream of the light receiving module in a direction of the return light, the polarization module includes N polarization filtering regions respectively corresponding to the N emitting regions in the light emitting module. The method further includes: receiving, by at least one of the polarization filtering regions of the polarization module in the at least part of the time period, the return light reflected by the detected object with different polarization angles that is outputted by the at least two emitting regions, where the at least one polarization filtering region is used to partially or fully filter the return light with the at least one polarization angle, and the light receiving module receives the return light after being filtered by the polarization module and outputs the excited photogenerated electrical signal.

In an embodiment, the emitting lights of the N emitting regions correspond to regions in a view field, and two emitting lights at least partially adjacent have an overlapping region.

In an embodiment, the emitting lights of the N emitting regions correspond to multiple regions in a view field, and in at least part of the time period, one of detected targets in one of the regions in the view field reflects at least part of the emitting light with a first polarization angle to another detected target in another region.

In an embodiment, the some receiving regions among the N receiving regions receive a light with at least two different polarization angles returned by the detected object.

In an embodiment, in at least part of the time period, the N receiving regions receive an echo obtained by one of the detected targets in one of the regions in the view field reflecting at least part of the emitting light with a first polarization angle to another detected target in another region.

In an embodiment, the light receiving module includes one or more image planes, and the light receiving module is provided with a photogenerated electrical signal conversion section configured at one of the image planes of the return light, and k image planes exist before the return light reaches the light receiving module, where k is an integer greater than or equal to 1.

In an embodiment, the polarization module is located at at least one of the k image planes.

In an embodiment, a proportion of an energy of the return light of the filtered polarization angle to a total return light energy of the polarization angle is not less than 20%.

In an embodiment, N is an even number greater than or equal to 2.

In an embodiment, N is 4, and two diagonally arranged emitting regions emit the light with polarization angles differing by 45° or 90°, and the light receiving module is provided with 4 receiving regions at polarization angles corresponding to the emitting regions.

In an embodiment, the polarization module is provided with 4 polarization filtering regions at the polarization angles corresponding to the emitting regions.

In a second aspect, a detection system is provided according to an embodiment of the present disclosure, to perform the detection method described in the first aspect above. The detection system includes a light emitting module, a processing module, and a light receiving module. The light emitting module includes N emitting regions, where N is an integer greater than or equal to 2, and lights respectively emitted from every two adjacent emitting regions among the emitting regions have different polarization angles. The light receiving module includes N receiving regions respectively corresponding to the N emitting regions in the light emitting module, and every two adjacent receiving regions among the receiving regions receive a light returned from a detected object at different polarization angles. At least some of the receiving regions in the light receiving module is configured to: in at least part of a time period, receive the return light reflected by the detected object with different polarization angles that is outputted by at least two emitting regions. The light receiving module is configured to generate a photogenerated electrical signal under excitation of the return light with at least one of the polarization angles after being partially or fully filtered, corresponding to at least a part of a region of the return light with different polarization angles. The processing module is configured to process the photogenerated electrical signal generated by the light receiving module under the excitation of the return light after being filtered, to obtain final target information of the detected object.

According to the detection method provided in the embodiment of the present disclosure, the detection method is performed by a detection system including a light emitting module, a processing module, and a light receiving module. The light emitting module includes N emitting regions, where N is an integer greater than or equal to 2, lights respectively emitted from every two adjacent emitting regions among the emitting regions having different polarization angles. The light receiving module includes N receiving regions respectively corresponding to the N emitting regions in the light emitting module, and every two adjacent receiving regions among the receiving regions receiving a light returned from a detected object at different polarization angles. The detection method includes: receiving, by at least some of the receiving regions in the light receiving module in at least part of a time period, the return light reflected by the detected object with different polarization angles that is outputted by at least two emitting regions; generating a photogenerated electrical signal by the light receiving module under excitation of the return light with at least one of the polarization angles after being partially or fully filtered, corresponding to at least a part of a region of the return light with different polarization angles; and processing, by the processing module, the photogenerated electrical signal generated by the light receiving module under the excitation of the return light after being filtered, to obtain final target information of the detected object. In this way, in the case that the detection method is applied to the object distance acquisition, the detector emitting light source is divided into N different regions, and the lights emitted from each adjacent two emitting regions have different polarization angles, so that it is equivalent that the emitting light source VCSEL array is divided, and each adjacent two emitting regions have different polarization angles. In this case, the lights outputted from the adjacent two light emitting regions have different polarization angles, and the light emitted from each region has certain identifiable characteristics. The projection view field of the emitting light of each region can be changed to 1/N of the whole view field by setting N regions. Further, the N emitting regions form the complete view field. Therefore, with the proposed solution, the targeted projection can be achieved on the premise of ensuring the detection range of the view field. With the light path between the return light to the receiving end or a polarization filter structure arranged on the receiving end, the reflected return light corresponding to directed emitted light can be identified, thus achieving the key object detection of key regions, and reducing or even eliminating the multipath interference.

Details of one or more embodiments of the present disclosure are presented in the drawings and description below. Other features, objects and advantages of the present disclosure are apparent from the specification, drawings and claims.

### BRIEF DESCRIPTION OF THE DRAWINGS

In order to illustrate technical solutions of embodiments of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic diagram showing modules of a detection system according to an embodiment of the present disclosure;

FIG. 2 is a schematic diagram showing an effect of multipath interference on detection according to an embodiment of the present disclosure;

FIG. 3 is a schematic diagram showing a detection result in the presence of the multipath interference according to the embodiment of the present disclosure;

FIG. 4 is a schematic diagram showing a multipath interference phenomenon according to another embodiment of the present disclosure;

FIG. 5 is a schematic diagram showing a simplified polarization structure according to an embodiment of the present disclosure;

FIG. 6 is a schematic diagram showing a system achieving multipath weakening at the emitting end and the receiving end according to an embodiment of the present disclosure;

FIG. 7 is a schematic diagram showing a system achieving multipath weakening at the emitting end and a polarization section located in at least one of image planes according to an embodiment of the present disclosure;

FIG. 8 is a schematic diagram showing signals received in four regions A, B, C and D at the receiving end without considering the multipath effect according to the embodiment of the present disclosure;

FIG. 9 is a schematic diagram showing signals received in the four regions A, B, C and D at the receiving end with considering the multipath interference according to the embodiment of the present disclosure; and

FIG. 10 is a schematic diagram showing signals received in the four regions A, B, C, and D at the receiving end by reducing the multipath effect with polarization-selective pixels according to an embodiment of the present disclosure.

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those skilled in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

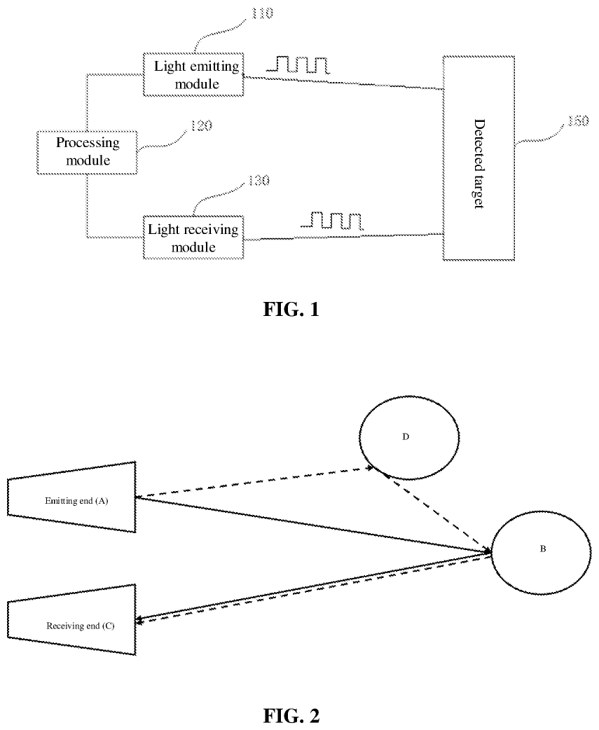

FIG. 1 is a schematic diagram showing modules of a detection system according to an embodiment of the present disclosure. As shown in FIG. 1, the detection system includes a light emitting module 110, a processing module 120, and a light receiving module 130. The following description is given by taking the ITOF distance measurement as an example. The light emitting module 110 emits a wave such as a sinusoidal wave, a square wave or a triangle wave, which is generally implemented as a laser with a certain wavelength in the distance measurement application, such as an infrared laser of 950 nm. The emitted light is projected into a view field, and a detected object 150 in the view field may reflect the projected laser light to form a return light. The return light enters the detection system and is received by the light receiving module 130. The light receiving module may include a photoelectric conversion section, such as an array sensor formed by CMOS or CCD. The light receiving module may further include multiple lenses to form one or more image planes, that is, the light receiving module contains one or more image planes. The photoelectric conversion section of the light receiving module is located at one of the image planes, which may receiving delay receiving signals of 0°, 90°, 180° and 270° with the most common four-phase solution. The four-phase distance calculation solution is illustrated herein by taking the sine wave as an example. The amplitude of the received signal is measured at four equally spaced points (for example, 90° or at a (¼)λ interval). The distance calculation formula of the four-phase distance measurement is shown as follows.

φ=ArcTan(A₁−A₃/A₂−A₄) (1)

A ratio of a difference between A₁ and A₃ to a difference between A₂ and A₄ is equal to the tangent of the phase angle. ArcTan is actually a bivariate inverse tangent function that can be mapped to the appropriate quadrant, and defined as 0° or 180° in the case of A₂=A₄ and A₁>A₃ or A₃>A₁, respectively.

The distance to the object is determined by the following equation.

d=c·φ/4π·f (2)

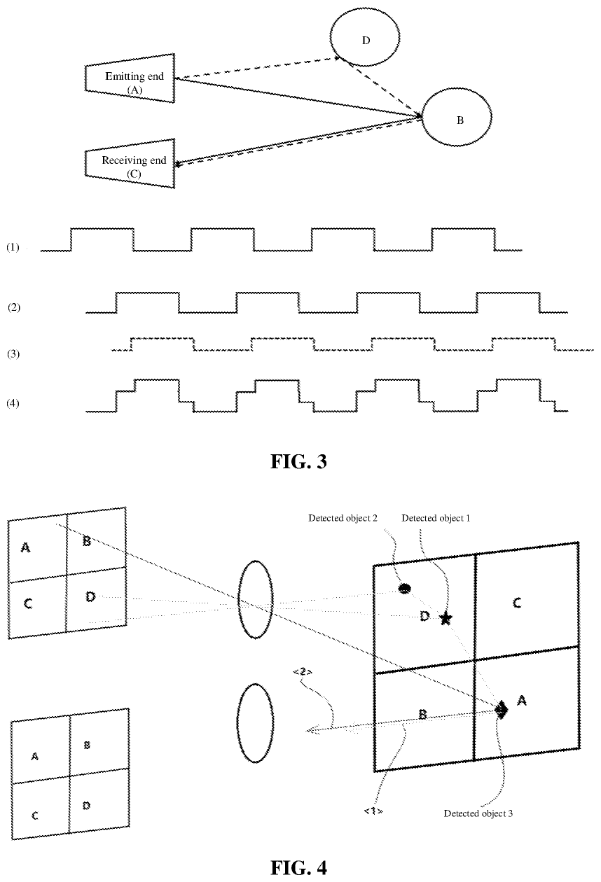

Further, the frequency of the emitted laser is required to be determined to perform the distance measurement, where c represents the light speed, φ represents a phase angle (measured in radians), and f represents a modulation frequency. With the above solution, the distance detection for the detected object in the view field can be achieved. However, the light arrives at the object via other paths, which results in the interference to the distance measurement signal as shown in FIG. 2, so that the error and interference to the actual distance measurement result exist. As shown in FIG. 2, the normal path is the light source (A)→the object (B)→the receiving end (C), in this case a time relationship between the received waveform and the emitted waveform is shown in FIG. 3. In a case that other objects near the target B reflect the signal light several times, an additional path is generated, that is, the light source (A)→the reflector (D)→the object (B)→the receiving end (C), as shown in FIG. 2. FIG. 3 illustrates the effect of the multiple-path on the waveform, where (1) represents a signal light emitted by itself, (2) represents an echo received by the normal path (A→B→C), (3) represents an echo generated by the additional path (A→D→B→C), and (4) represents an echo received by the normal path and the additional path together. In the scenario in FIG. 1, due to the additional reflection in the light movement path and the increase of the light distance, a weak and relatively backward echo signal is generated at the received signal end. In the process of performing the test by the integration method, the interference to the amount of charges obtained by the integration exists, which further interferes with the actual distance measurement result and affects the correctness of the result.

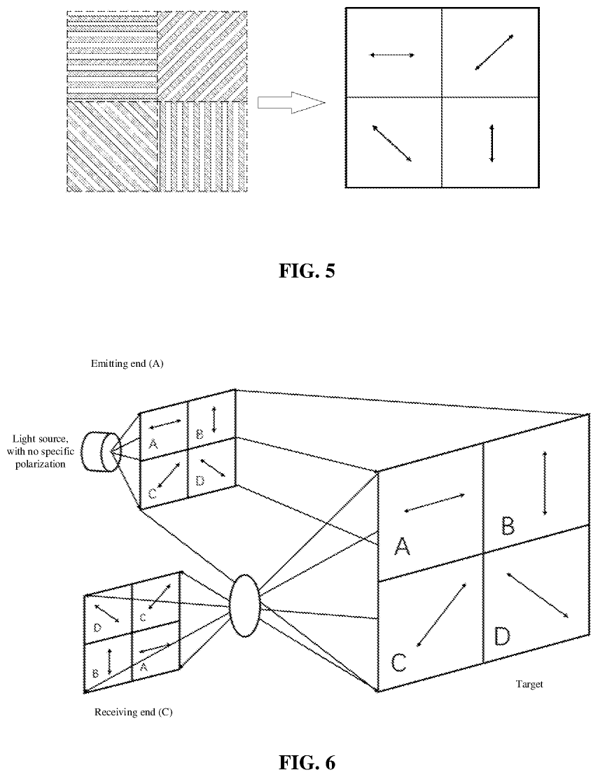

In the solution mentioned in the section of BACKGROUND, key regions are pre-identified to perform key projection. In this way, multipath interference can be identified by avoiding the projection for interference regions, to further obtain the detection result after eliminating the multipath interference. However, this solution has problems of efficiency and complexity. Therefore, it is helpful to design a solution for targeted emission to reduce or eliminate the multipath interference. A partitioning emission solution is given by previous studies to solve this problem. In a filed Chinese patent application No. 202011040936.9 titled “DEVICE AND METHOD FOR MEASURING DISTANCE BY TIME OF FLIGHT”, a solution that the emitting end is partitioned to perform emitting in time, and the distance information of the detected object in the complete view field is obtained by synthesis, which overcomes the problem of the limited view field in the solution shown in the section of BACKGROUND, and achieves a feasible solution to eliminate the problem of the multipath interference in large view field requirements by entering the mode by manual selection, self-adaption, or the like. In order to further ensure the efficient and continuous elimination and reduction of the multipath interference, more studies are made in the present disclosure. In the distance measurement process of an ordinary TOF sensor, if both the emitting end and the receiving end are divided into N regions (where N is an integer greater than or equal to 2), these regions are in fact conjugated in a group of imaging systems, that is, the light emitted from a region A at the emitting end is required to form a real image on a region A at the receiving end by the receiving system (the receiving system herein includes but is not limited to lens imaging, small hole imaging, etc.) In other words, in the entire view field, the emitting end is artificially divided into N different regions, and the emitted lights respectively from these N emitting regions correspond to the N regions in the view field. In the normal detection process, due to the correspondence of imaging, the receiving end correspondingly receives the reflected return light in each different view field, that is, the receiving end is correspondingly divided into N regions. In the case of introduction of the multipath interference, the following description is further given with reference to FIG. 4. As shown in FIG. 4, the emitting end is considered as a combination of four regions A, B, C, and D. In this case, the multipath interference problem is re-analyzed. A detected object 1 and a detected object 2 exist in the region D of the view field, and a detected object 3 exists in the region A. In this case, the laser light emitted from the region D of the emitting end is projected into the region D of the view field, and the detected object 1 may reflect the laser light to the detected object 2 or the detected object 3. In this scenario, since the detected object 1 and the detected object 2 exist in the range of the same emitting region D, the interference caused by reflection is relative weak, and has a relative small interference on the final distance information, while can be further weaken by dividing the emitting end into a greater number of regions. In this case, the inter-regional multipath interference in fact is an important reason for the accuracy of the detection result. In this scenario, the original correct reflected return light is <2>. However, since the laser light reflected from the detected object 1 in the region D enters the region A, the reflected return light further contains a multipath interference light <1>caused by the presence of multipath reflection in the view field. That is, in at least part of the time period, the emitted lights of at least two different emitting regions are reflected back to the same region at the receiving end. Based on the technical idea of the solution mentioned in the section of BACKGROUND, different regions of the emitting end are designed as having light sources with different characteristics, for example, the emitting regions are set to have different polarization angles by utilizing the polarization characteristics and the emitting lights of adjacent two emitting regions have different polarization angles. In this way, the distinction for the detection regions in the view field is achieved, that is, the projection view field of the emitting light of each region can be changed to 1/N of the whole view field by setting N regions. Further, the N emitting regions form the complete view field. Therefore, with the proposed solution, the targeted projection can be achieved on the premise of ensuring the detection range of the view field. Moreover, in order to ensure the accuracy of the detection result, two adjacent regions may be set to have an overlapping region, which can ensure that the result of the entire detector array is accurate and overall. With the light path between the return light to the receiving end or a polarization filter structure arranged on the receiving end, as shown in FIG. 5, the reflected return light corresponding to directed emitted light can be identified, thus achieving the key object detection of key regions, and reducing or even eliminating the multipath interference, and further avoiding the multiple detection of synthetic results. This solution may be used in combination with the partitioning emitting solution, which is not limited herein. The above drawing is only illustrative, 4 regions, 8 regions, or 6 regions can be set in an actual implementation, where N is optimally an even number greater than or equal to 2, to achieve the reliability of the partition. The layout rule is not limited herein, as long as the emitted lights of two adjacent emitting regions have different polarization angles, and further the difference between the polarization angles of the emitted lights from the two adjacent emitting regions is not less than 45°.

FIG. 6 shows a polarizer structure, by which the light source is divided into four different regions. The array emitting end system is called as a light emitting system of VCSEL+diffuser. A polarizer having the same size as the diffuser may be placed on the diffuser, and the polarizer is divided into N regions based on the division of the emitting regions, where the regions have different polarization directions. The polarization directions of the different regions of the polarizer are the same as the system design. The polarizer may be designed as being variable, for example, different polarization angles are outputted by voltage control. Further, the polarizer may be arranged according to the actual demand so that the polarization angles of the light emitted from the two diagonally arranged emitting regions differ by 90° or 45°. Moreover, if the polarization module has an adjustable function, the polarization angles of different regions may be set or adaptively adjusted. The implementation of the polarization is not limited herein. The polarization setting is not necessarily implemented as the combination of 0°, 45°, 90° and 180°, and the effect of the present disclosure can be achieved by means of other polarization angles, as long as a proportion of an energy of the return light of the filtered polarization angle to a total return light energy of the polarization angle is not less than 20% so as to weaken the impact of the polarization. With the solution of the present disclosure, all regions of the emitting end and all regions of the receiving end work simultaneously in the distance measurement process, to obtain the distance measurement result at the same time, avoiding that the synthesis of multiple detection results is performed for multiple times to obtain the final result.

The polarization process at the receiving end is performed to differentiate the multipath effect at the emitting end, and the pixel processing is performed by adding a line grating on the pixel, where other parameters such as grating material, period, and line width depend on the wavelength of the signal light. The line grating is mainly used to filter all or part of the light that does not match the polarization direction of the emitted light in the corresponding region, that is, at least one of the light receiving module receives the return light with different polarization angles from at least two emitting regions, and the grating can fully or partially filter the interference light caused by the multipath phenomenon of the polarization angle that does not correspond to the region.

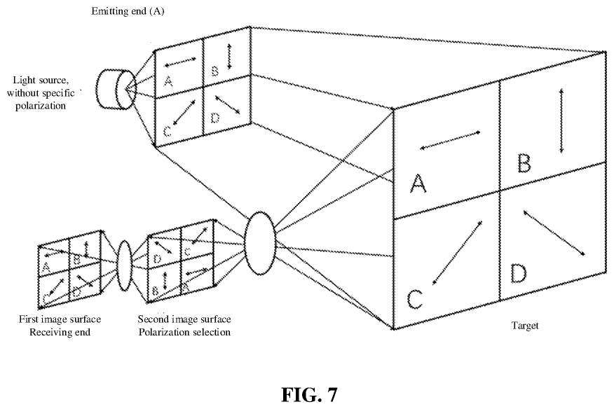

In FIG. 6, for matching the polarization of the emitting end, the N regions are set at the receiving end, each adjacent two regions have different polarization angles. The receiving end and the emitting end are each divided into four regions, of which polarization directions are as shown in FIG. 6. It can be seen that, the four regions perform the emitting with four different polarizations, and the corresponding four regions perform the receiving with the corresponding polarizations. In addition, a polarization section may be provided in a light path between the return light and the receiving end. In the light receiving system, light elements (including but not limited to lens, lens group, wave band piece, Fresnel lens, small hole imaging and other components or manners) may be used to form one or more image planes for real imaging between the measured object and the photoelectric sensor array, where the relationship of these image planes are as shown in FIG. 7. One of the above several image planes is chosen as the image plane for the polarization selection, and a sub-regional polarization filter (including but not limited to polarizer, ½ wavelength wave plate, liquid crystal light modulator) matching the position and direction of a modulated polarization sub-region of the emitted light is placed on this image plane. After the received light passes through the polarization filter, the light component with a different polarization direction from the filter are significantly reduced. By this method, the light that is not emitted from the partition of the emitting end corresponding to the region on the photodetector can be effectively reduced, effectively reducing the error caused by the multipath effect on the ITOF distance measurement. In this way, no special process is required at the receiving end in the case of ensuring the original settings.

In a target system as shown in FIG. 4, it is assumed that, at least 10% of the light from one region generates crosstalk for other regions (or 10% of the light from each region generates crosstalk for the other regions) and is reflected back to the corresponding region at the receiving end. In the four-region target system, a correspondence between the reflectance and the crosstalk for different regions is shown in Table 1.

TABLE 1
Transmittance of different polarization-selected
pixels under different polarized lights

| Polarization direction | 0° | 45° | 90° | 135° |
|---|---|---|---|---|
| 0° | 100% | 50% | 1% | 50% |
| 45° | 50% | 100% | 45% | 1% |
| 90° | 1% | 50% | 100% | 50% |
| 135° | 50% | 1% | 50% | 100% |

It can be seen from results of the above table that, with the solution of the present disclosure, the proportion of the return light with the polarization angle generating the crosstalk for other regions due to the multipath interference that is required to be filtered out to the total return light of the polarization angle is not less than 50%, thereby weakening or eliminating the multipath interference.

It is assumed that 10% of the light from each region generates the crosstalk for other regions and is reflected back to the corresponding region at the receiving end. By the polarization receiving end as shown in FIG. 5 or similarly by the polarization section arranged on at least one image plane in the light path as shown in FIG. 6, an actual multipath effect result table under the multipath effect is obtained, as shown in Table 2 below.

TABLE 2
Reflectance of different targets under multipath effect

| Region | A | B | C | D |
|---|---|---|---|---|
| Reflectance | 90% | 70% | 80% | 85% |
| A | — | 10% | 10% | 5% |
| B | 10% | — | 5% | 10% |
| C | 10% | 5% | — | 10% |
| D | 5% | 10% | 10% | — |

When assuming a flight time has a delay of 20 ns, regional delay results of different regions under the multipath influence are obtained, as shown in Table 3 below.

TABLE 3
Reflectance of different targets under multipath effect

| Region | A | | B | | C | | D | |
|---|---|---|---|---|---|---|---|---|
| Light delay | 20 | ns | 20 | ns | 20 | ns | 20 | ns |

| | | | | | | | |
|---|---|---|---|---|---|---|---|
| A | — | 4 | ns | 4 | ns | 5.66 | ns |

| | | | | | | | |
|---|---|---|---|---|---|---|---|
| B | 4 | ns | — | 5.66 | ns | 4 | ns |

| | | | | | | | |
|---|---|---|---|---|---|---|---|
| C | 4 | ns | 5.66 | ns | — | 4 | ns |

| | | | | | | | |
|---|---|---|---|---|---|---|---|
| D | 5.66 | ns | 4 | ns | 4 | ns | — |

Further, the statistics is performed on measurement results of the whole system to obtain a light path difference statistic caused by the multipath effect, as shown in Table 4 below.

TABLE 4
Light path difference of different regions under multipath effect

| Region | A | | B | | C | | D | |
|---|---|---|---|---|---|---|---|---|
| Light delay | 3 | m | 3 | m | 3 | m | 3 | m |

| | | | | | | | |
|---|---|---|---|---|---|---|---|
| A | — | 0.6 | m | 0.6 | m | 0.85 | m |

| | | | | | | | |
|---|---|---|---|---|---|---|---|
| B | 0.6 | m | — | 0.85 | m | 0.6 | m |

| | | | | | | | |
|---|---|---|---|---|---|---|---|
| C | 0.6 | m | 0.85 | m | — | 0.6 | m |

| | | | | | | | |
|---|---|---|---|---|---|---|---|
| D | 0.85 | m | 0.6 | m | 0.6 | m | — |

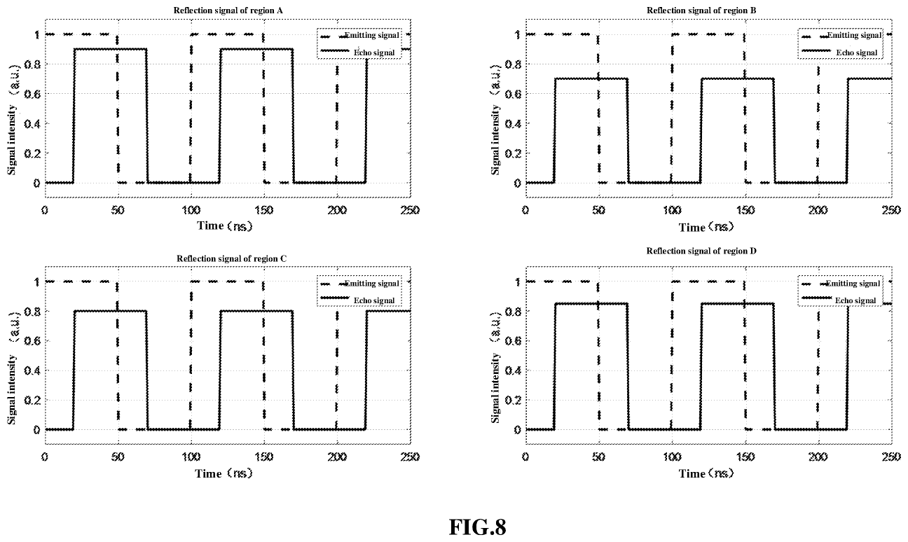

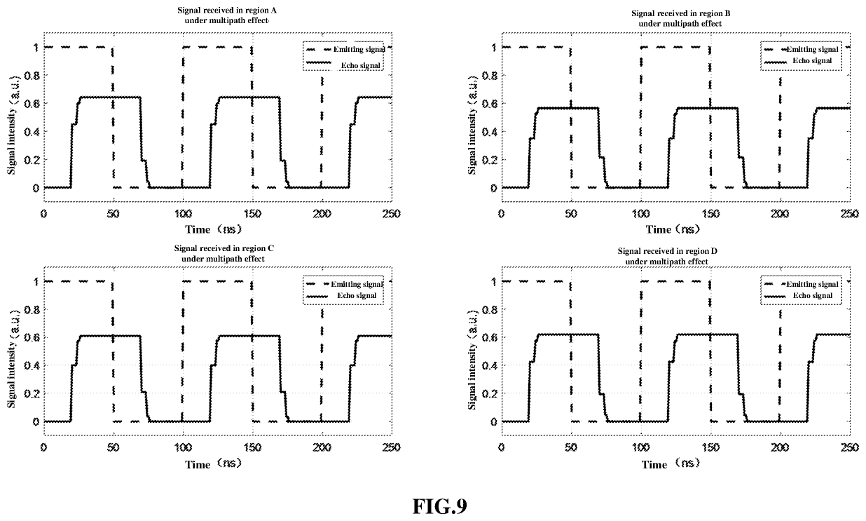

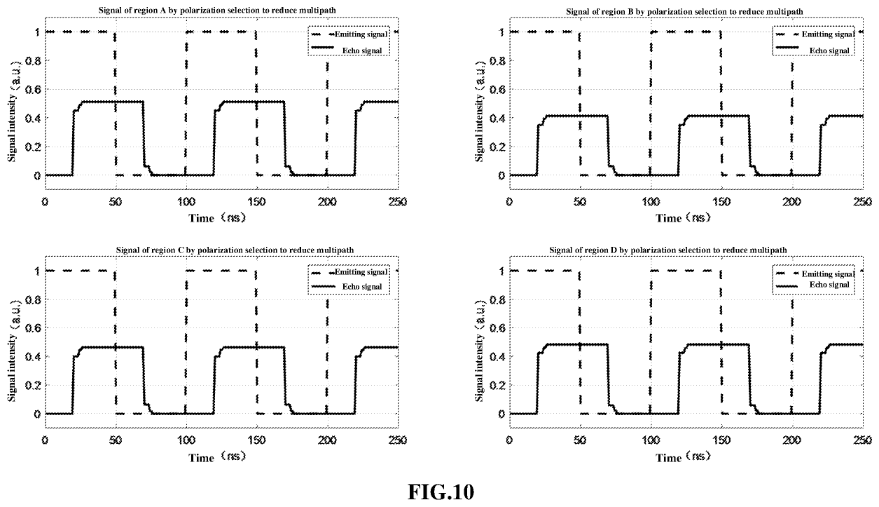

In a case that no crosstalk is generated, the signals respectively received in the four regions A, B, C, and D at the receiving or in four different receiving regions corresponding to the return light filtered by a polarization section of a separate image plane are shown in FIG. 8. In the case of considering the multipath crosstalk, the total signals respectively received in the four regions A, B, C, and D at the receiving end are shown in FIG. 9 (without the polarization filtering). In the case of using polarization received pixels, the total signals respectively received in the four regions A, B, C, and D at the receiving end are shown in FIG. 10. It can be seen from the above results that, the interference caused by the multipath has a certain effect on the waveform, which provides identifiable technical solutions for subsequent processing. The accounting is performed on results for different cases under the existing assumptions. The distance measurement results in cases of without considering the multipath effect, considering the multipath effect but no interference cancellation, and considering the multipath effect and using polarization-selective pixels to reduce the multipath interference are summarized in Table 5.

TABLE 5
Comparison of distance measurement results under different conditions

| | A | | B | | C | | D | |
|---|---|---|---|---|---|---|---|---|
| Without multipath | 3 | m | 3 | m | 3 | m | 3 | m |
| With multipath | 3.1976 | m | 3.2467 | m | 3.2213 | m | 3.2073 | m |
| Error rate | 6.56% | | 8.22% | | 7.38% | | 6.91% | |
| Distance measurement results by | 3.0828 | m | 3.1040 | m | 3.0914 | m | 3.0839 | m |
| polarization selection to reduce | | | | | | | | |
| multipath | | | | | | | | |

| | | | | |
|---|---|---|---|---|
| Error rate | 2.76% | 3.47% | 3.05% | 2.80% |

It can be seen from the above results that, with this solution, the error caused by the multipath phenomenon is significantly reduced after at least 50% filtering of the multipath interference light in at least one region of at least one polarization angle. In practice, the multipath interference is not limited to occurring in one plane, and the advantages brought by the design of the present disclosure are similar. The accounting and the effect for one case are given, and the multipath phenomenon is not limited to this assumption in the explanation. Since the multipath interference light caused due to the polarization filtering is different from the actual return light, the identification may be performed by some subsequent processing, which is not limited herein.

In summary, the solution of the present disclosure has at least the following technical effects.
1) The distance measurement error caused by the multipath effect can be significantly reduced.
2) No additional modulation operations are required for the emitting end and the receiving end.
3) The polarization angle can be flexibly adjusted by replacing the polarizer.

It should be noted that, relational terms such as “first” and “second” herein are only used to distinguish one entity or operation from another entity or operation, and do not necessarily require or imply there is such actual relationship or sequence between these entities or operations. Moreover, terms “comprising”, “including” or any other variations thereof are intended to encompass a non-exclusive inclusion, such that a process, a method, an article or a device including a series of elements includes not only those elements, but also includes other elements that are not explicitly listed or inherent to such the process, method, article or device. Without further limitation, an element defined by a phrase “including a . . . ” does not preclude the presence of additional identical elements in a process, method, article or device including the element.

It should further be noted that the terms “module,” “unit,” and “component” as used in this specification are intended to denote a computer-related entity, which may be implemented by hardware, software, a combination of hardware and software, or software in execution. For example, the component may be but is not limited to, a process running on a processor, a processor, an object, an executable code, an executed thread, a program, or a computer. As an illustration, both the application running on the server and the server may be components. One or more components may reside in a process and/or an executed thread, and the components may be located in a computer or distributed between two or more computers.

Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure. It should be noted that similar numerals and letters refer to similar items in the following drawings. Therefore, if an item is defined in a drawing, the item is not required to be further defined and explained in subsequent drawings. Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure.

1. A detection method, performed by a detection system comprising a light emitting module, a processing module and a light receiving module, the light emitting module comprising N emitting regions, wherein N is an integer greater than or equal to 2, lights respectively emitted from every two adjacent emitting regions among the emitting regions having different polarization angles, the light receiving module comprising N receiving regions respectively corresponding to the N emitting regions in the light emitting module, every two adjacent receiving regions among the receiving regions receiving a light returned from a detected object at different polarization angles, the detection method comprising:
receiving, by at least some of the receiving regions in the light receiving module in at least part of a time period, the return light reflected by the detected object with different polarization angles that is outputted by at least two emitting regions;
generating a photogenerated electrical signal by the light receiving module under excitation of the return light with at least one of the polarization angles after being partially or fully filtered, corresponding to at least a part of a region of the return light with different polarization angles; and
processing, by the processing module, the photogenerated electrical signal generated by the light receiving module under the excitation of the return light after being filtered, to obtain final target information of the detected object.

2. The detection method according to claim 1, wherein the detection system further comprises a polarization module arranged upstream of the light receiving module in a direction of the return light, the polarization module comprises N polarization filtering regions respectively corresponding to the N emitting regions in the light emitting module, and wherein the method further comprises:
receiving, by at least one of the polarization filtering regions of the polarization module in the at least part of the time period, the return light reflected by the detected object with different polarization angles that is outputted by the at least two emitting regions, wherein the at least one polarization filtering region is used to partially or fully filter the return light with the at least one polarization angle, and the light receiving module receives the return light after being filtered by the polarization module and outputs the excited photogenerated electrical signal.

3. The detection method according to claim 1, wherein the emitting lights of the N emitting regions correspond to regions in a view field, and two emitting lights at least partially adjacent have an overlapping region.

4. The detection method according to claim 1, wherein the emitting lights of the N emitting regions correspond to a plurality of regions in a view field, and in at least part of the time period, one of detected targets in one of the regions in the view field reflects at least part of the emitting light with a first polarization angle to another detected target in another region.

5. The detection method according to claim 1, wherein the some receiving regions among the N receiving regions receive a light with at least two different polarization angles returned by the detected object.

6. The detection method according to claim 1, wherein in at least part of the time period, the N receiving regions receive an echo obtained by one of the detected targets in one of the regions in the view field reflecting at least part of the emitting light with a first polarization angle to another detected target in another region.

7. The detection method according to claim 2, wherein the light receiving module comprises one or more image planes, and the light receiving module is provided with a photogenerated electrical signal conversion section configured at one of the image planes of the return light, and k image planes exist before the return light reaches the light receiving module, wherein k is an integer greater than or equal to 1.

8. The detection method according to claim 7, wherein the polarization module is located at at least one of the k image planes.

9. The detection method according to claim 1, wherein a proportion of an energy of the return light of the filtered polarization angle to a total return light energy of the polarization angle is not less than 20%.

10. The detection method according to claim 1, wherein N is an even number greater than or equal to 2.

11-12. (canceled)

13. A detection system, comprising:
a light emitting module comprising N emitting regions, wherein N is an integer greater than or equal to 2, and lights respectively emitted from every two adjacent emitting regions among the emitting regions have different polarization angles;
a light receiving module comprising N receiving regions respectively corresponding to the N emitting regions in the light emitting module, and every two adjacent receiving regions among the receiving regions receive a light returned from a detected object at different polarization angles; and
a processing module, wherein
at least some of the receiving regions in the light receiving module is configured to: in at least part of a time period, receive the return light reflected by the detected object with different polarization angles that is outputted by at least two emitting regions;
the light receiving module is configured to generate a photogenerated electrical signal under excitation of the return light with at least one of the polarization angles after being partially or fully filtered, corresponding to at least a part of a region of the return light with different polarization angles; and
the processing module is configured to process the photogenerated electrical signal generated by the light receiving module under the excitation of the return light after being filtered, to obtain final target information of the detected object.

14. The detection system according to claim 13, further comprising:
a polarization module arranged upstream of the light receiving module in a direction of the return light, wherein
the polarization module comprises N polarization filtering regions respectively corresponding to the N emitting regions in the light emitting module; and
in the at least part of the time period, at least one of the polarization filtering regions of the polarization module receives the return light reflected by the detected object with different polarization angles that is outputted by the at least two emitting regions, wherein the at least one polarization filtering region is used to partially or fully filter the return light with the at least one polarization angle, and the light receiving module receives the return light after being filtered by the polarization module and outputs the excited photogenerated electrical signal.

15. The detection system according to claim 13, wherein the emitting lights of the N emitting regions correspond to regions in a view field, and two emitting lights at least partially adjacent have an overlapping region.

16. The detection system according to claim 13, wherein the emitting lights of the N emitting regions correspond to a plurality of regions in a view field, and in at least part of the time period, one of detected targets in one of the regions in the view field reflects at least part of the emitting light with a first polarization angle to another detected target in another region.

17. The detection method according to claim 13, wherein the some receiving regions among the N receiving regions receive a light with at least two different polarization angles returned by the detected object.

18. The detection method according to claim 13, wherein in at least part of the time period, the N receiving regions receive an echo obtained by one of the detected targets in one of the regions in the view field reflecting at least part of the emitting light with a first polarization angle to another detected target in another region.

19. The detection method according to claim 14, wherein the light receiving module comprises one or more image planes, and the light receiving module is provided with a photogenerated electrical signal conversion section configured at one of the image planes of the return light, and k image planes exist before the return light reaches the light receiving module, wherein k is an integer greater than or equal to 1.

20. The detection method according to claim 19, wherein the polarization module is located at at least one of the k image planes.

21. The detection method according to claim 13, wherein a proportion of an energy of the return light of the filtered polarization angle to a total return light energy of the polarization angle is not less than 20%.

22. The detection method according to claim 13, wherein N is an even number greater than or equal to 2.

23-24. (canceled)
